(19) United States
(12) Patent Application Publication
(10) Pub. No.: US 2014/0337168 A1
(43) Pub. Date: Nov. 13, 2014

(54) ENVIRONMENT AND METHODS FOR GIFT GIVING

(71) Applicant: PANDOMI, INC., BOSTON, MA (US)

(72) Inventor: Tharin Laorauvirodge, Boston, MA (US)

(73) Assignee: PANDOMI, INC., BOSTON, MA (US)

(21) Appl. No.: 14/214,831

(22) Filed: Mar. 15, 2014

Related U.S. Application Data
(60) Provisional application No. 61/800,867, filed on Mar. 15, 2013.

(51) Int. Cl. G06Q 30/06

(52) U.S. Cl. CPC G06Q 30/0633
USPC 705/26.8

(57) ABSTRACT

The present invention provides methods and systems for gift giving, including enabling gift receivers to publish a gift list, enabling gift givers to view the gift list, and enabling gift givers to engage in crowd funding to purchase one or more gifts from a gift list.

### CROSS REFERENCE TO RELATED APPLICATIONS

The present application claims priority to U.S. provisional patent application No. 61/800,867, filed Mar. 15, 2013, the entire contents of which is hereby incorporated by reference herein.

### BACKGROUND OF THE INVENTION

Gift giving can often be a time consuming, awkward, and downright wasteful endeavor. In many cases, it is difficult to know what to give someone because the person choosing the gift does not know what the person to receive the gift desires, and after much searching, a gift is purchased and given that is not desired, not appreciated, and not used. The gift receiver is in a different predicament, but no less awkward: how to let people know what gifts he or she really wants, particularly if they are too expensive to reasonably expect even the most generous of friends or family to purchase.

### BRIEF DESCRIPTION OF THE DRAWINGS

FIG. 1 depicts an exemplary embodiment of a provided method and system 100.

FIG. 2 depicts an example header bar 200 and exemplary user interfaces.

FIG. 3 depicts a screen shot 300 interface for creating a gift list.

FIG. 4 depicts a screen shot 400 interface for selecting gift choices.

FIG. 5 depicts a screen shot 500 for a user to view a published gift list.

FIG. 6 depicts a screen shot 600 interface for a gift giver to view a user's published gift list.

FIG. 7 depicts a screen shot 700 interface for a gift giver to contribute to a user's gift list.

### DETAILED DESCRIPTION OF CERTAIN EMBODIMENTS

The present invention encompasses the recognition that a significant number of gift giving instances are inefficient, if not complete failures, because (i) the gift receiver lacks an efficient and socially acceptable way of notifying friends and family of what gifts he or she desires, (ii) gift givers usually do not know what type of gift is desired, and (iii) many gifts that are desired are out of the price range of the typical gift giver. The methods and environments provided herein provide a solution to these problems by, among other things, providing a way for gift receivers to publish a gift list, enabling gift givers to view the gift list, and enabling gift givers to engage in crowd funding to purchase one or more gifts from a gift list.

In certain embodiments, the present invention provides a method comprising steps of:
a. facilitating a first party (e.g., a gift receiver) in creating a gift list comprised of one or more gift items sold by one or more networked merchants;
b. providing for at least two other parties (e.g., gift givers) to view the gift list;
c. providing for the at least two other parties to fund the one or more gift items by contributing money to a fund pool; and
d. causing the purchase of at least one gift item from the networked merchant.

In some embodiments, a networked merchant is any merchant capable of selling goods or services via a network (e.g., the internet). In some embodiments, a networked merchant itself implements the methods and systems described herein. In some embodiments, a networked merchant interacts via the methods and systems described herein with an entity implementing the methods and systems.

In some embodiments, a provided method comprises causing the closing of a sale of the gift item when the money in the fund pool equals or exceeds the price of the gift item. In certain embodiments, a provided method comprises causing delivery of the gift item to the first party. In some embodiments, a provided method comprises enabling the first party to view the fund pool value. In certain embodiments, a provided method comprises enabling the first party to contribute money to the fund pool.

In some embodiments of provided methods, a first time limit is specified for the contribution of money to the fund pool by the at least two other parties. In some embodiments, a first time limit may be later extended by a first party. In certain embodiments of provided methods, the first party ranks the gift items on the gift list in order of preference. In some embodiments, the ranking order determines the priority by which money in the fund pool is applied to the purchase of gift items. In some embodiments of provided methods, the closing of a sale of the top-ranked gift item is triggered when the money in the fund pool equals or exceeds the price of the top-ranked gift item. In certain embodiments, the top-ranked gift item is not purchased if the fund pool does not equal or exceed the price of the top-ranked gift item before expiration of a first time limit. In some embodiments, upon expiration of a first time limit, the closing of a sale of the next highest-ranked gift item is triggered if the money in the fund pool equals or exceeds the price of the next-ranked gift item. In some embodiments, upon expiration of a time limit, the closing of a sale is triggered for the most highly-ranked gift item for which the money in the fund pool equals or exceeds the price of the gift item. In some embodiments, more than one gift item sale is closed, in order of ranking and where the fund pool equals or exceeds the price of more than one gift item.

In certain embodiments, provided methods comprise enabling the first party to contribute money to the fund pool after expiration of a first time limit. In some embodiments, a second time limit is specified for the contribution of money by the first party.

In some embodiments, provided methods comprise enabling the one or more networked merchants to modify the listed price of a gift list item. In some embodiments, provided methods are computer-implemented.

In another aspect, the present invention provides a system comprising:
one or more processors; and
a memory, the memory storing instructions that, when executed by the processor, cause the processor to:
receive, via a network, from a first party computing device, a selection of one or more gift items offered for sale by one or more networked merchants, wherein the selection comprises a gift list;
receive, via the network, from at least two other party computing devices, payments into a fund pool;
analyze, via the processor, whether the fund pool is of sufficient value to purchase one or more gift items on the gift list; and
cause, via the network, the purchase of at least one gift item from a networked merchant.

In some embodiments, the one or more processors comprise a plurality of networked processors. In some embodiments, a plurality of networked processors are distributed in a cloud network environment.

In another aspect, the present invention provides a non-transitory computer readable medium, where the computer readable medium stores instructions that, when executed by the processor, cause the processor to:
receive, via a network, from a first party computing device, a selection of one or more gift items offered for sale by one or more networked merchants, wherein the selection comprises a gift list;
receive from at least two other party computing devices, payments into a fund pool;
analyze whether the fund pool is of sufficient value to purchase one or more gift items on the gift list;
cause the purchase of at least one gift item from a networked merchant.

In some embodiments, provided systems and computer readable media implement one or more of the methods described herein.

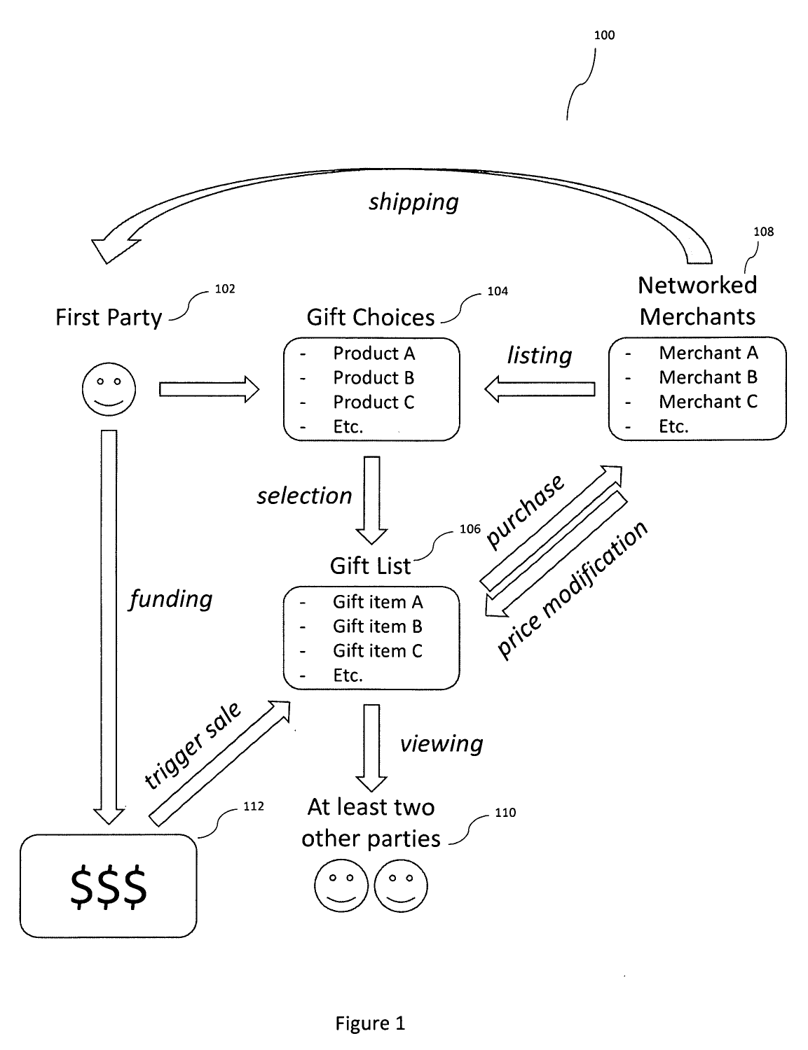

FIG. 1 is an exemplary embodiment of a provided method and system 100. In some embodiments, a first party (e.g., the gift receiver) 102 selects one or more gift choices 104, which then become part of a gift list 106 comprised of one or more gift items that correspond to the gift choices. It will be appreciated that in some embodiments, a first party is not the person who will ultimately receive a gift, but rather is a sponsor or benefactor who uses the provided method and system to facilitate giving a gift to someone else (e.g., a surprise gift). As used herein, the term “first party” includes both a gift receiver and such a gift sponsor or benefactor. In some embodiments, the gift choices that can be selected by a first party 102 are determined or provided by one or more networked merchants 108. For example, merchant A can make available one or more gift choices, merchant B can make available one or more gift choices, and so on. In some embodiments, the price of each gift choice is determined by each merchant. In certain embodiments, a price is inclusive of any relevant taxes. Gift choices can comprise virtually anything a first party would want for himself or herself, for example any consumer goods or services. By way of nonlimiting example, consumer goods include electronics, jewelry, entertainment media, home goods, furniture, automobiles, clothing, toys, sporting goods, baby or children's products, personal hygiene products, appliances, etc. By way of nonlimiting example, services include those for personal hygiene and grooming, accommodations, travel, labor, recreation, entertainment, etc.

In some embodiments, gift items on gift list 106 are ranked by a first party. For example, gifts may be ranked in ordinal fashion in order of preference, price, or other criteria. In some embodiments, a first party will rank based on preference. In other embodiments, a first party will rank at least partly based on price (e.g., first is most expensive, second is 2^{nd} most expensive, and so on). This is because, as explained below, in some embodiments, gifts are purchased according to ranking order. In some embodiments, when a gift list comprises a single gift item, the gift item is considered the top-ranked gift item.

In some embodiments, at least two other parties 110 (i.e., a second, third, or more parties, the gift givers) view the gift list 106. In some embodiments, the at least two other parties view the gift list over a network. In some embodiments, the at least two other parties are notified of the existence of a gift list through a communication from the first party. Such communications can take any form, including but not limited to oral, written, or electronic (e.g., email, social media, SMS text, etc.) communications. In other embodiments, the at least two other parties can search for a first party's gift list by querying via the network (e.g., by name, email, social media identifier, etc.)

The at least two other parties 110 may contribute to purchasing one or more items on a gift list 106 by contributing money to a fund pool 112. In some embodiments, the methods provided by the present invention include a crowd funding feature, wherein the funds used to purchase gifts are contributed by multiple gift giving parties. In some embodiments, a fund pool is a separate fund for each item on a gift list 106. In some embodiments, a fund pool is a common fund for all items on a gift list 106. Funds can be contributed to a fund pool by any electronic payment means, including, but not limited to credit cards, debit cards, bank account transfers, PayPal™, other online bank accounts or credits, a balance provided by the methods and system described herein, etc. In some embodiments, the exact amount of funds contributed is specified by the party contributing the funding. In some embodiments, the amount of funds contributed is based on a multiplier of a predetermined amount that the contributing party selects (e.g., one, two, or more times $10, $30, or $50). In some embodiments, a first party can view the value of a fund pool 112.

When the fund pool value equals or exceeds the price of one or more items on gift list 106, a sale is triggered, causing the purchase of at least one gift item on gift list 106 from one or more networked merchants 108. In some embodiments, the triggering of a sale comprises closing the sale of a gift item with a networked merchant. In some embodiments, the order in which a gift item is purchased is controlled by the ranking of gift items on the gift list 106. In some embodiments, the ranking order determines the priority by which money in the fund pool is applied to the purchase of gift items. For example, in some embodiments no gift item is purchased until the value of the fund pool equals or exceeds the price of the top-ranked (first) gift item on gift list 106. But if the value of the fund pool equals or exceeds the price of the top-ranked gift item on gift list 106, the sale of the top-ranked item is triggered.

In certain embodiments, a first time limit is specified for the contribution of money to the fund pool 112 by the at least two other parties 110. In certain embodiments, a first time limit is specified by a first party 102. In some embodiments, if the fund pool 112 does not equal or exceed the price of the top-ranked gift item before expiration of a first time limit, the sale of a top-ranked gift item is not triggered. In such cases, the closing of a sale of the next highest-ranked gift item on gift list 106 is triggered if the value of the fund pool 112 equals or exceeds the price of the next-ranked (second) gift item on gift list 106. If the fund pool 112 does not equal or exceed the price of the next-ranked gift item on gift list 106, the process continues in order of ranking until the value of the fund pool 112 equals or exceeds the price of a gift list item. In some embodiments, upon expiration of the time limit, the closing of a sale is triggered for the most highly-ranked gift item for which the value in the fund pool equals or exceeds the price of the gift item. In some embodiments, the sale of more than one gift item on gift list 106 is closed, in order of ranking and where the fund pool 112 equals or exceeds the price of more than one gift item. If the value of the fund pool 112 does not equal or exceed the price of any gift list item, then no gift is purchased at the expiration of a first time limit. In some embodiments, the first time limit may be extended by a first party.

In some embodiments, a first party can contribute funding to the funding pool 112. In some embodiments, this funding occurs after expiration of a first time limit. For example, upon expiration of a first time limit, a first party 102 may be notified that the fund pool 112 value is insufficient to purchase any gift item on gift list 106, and the first party 102 is then able to “top-off” the fund by contributing enough money to cause the fund pool 112 value to equal or exceed the price of a gift item on gift list 106. In certain embodiments, a second time limit is specified for the contribution of money by the first party. In some embodiments, a first party 102 receives notification after a gift has been purchased, but when value still remains in the fund pool 112. In such cases, a first party 102 can decide whether to add additional funds to the gift list 106 or allow the balance to remain in the account of first party 102. Such balances could, in some embodiments, be applied to fund other gift lists of the first party or another party's gift list.

In some embodiments, the one or more networked merchants 108 can modify the listed price of an item on gift list 106. For example, a merchant may offer a sale on an item after it has already been selected and placed on gift list 106. In some embodiments, a merchant is notified that a funding pool is near the listed price (for example, within a certain absolute amount or percentage of the listed sale price), and the merchant may elect to lower the price prior to expiration of a first time limit so that the value of a fund pool 112 equals or exceeds the price of an item on gift list 106.

Upon purchase of a gift item from a networked merchant, the gift item is shipped to a first party 102. In some embodiments, a networked merchant directly ships the item. In other embodiments, a networked merchant causes the gift item to be shipped by a third party.

In certain embodiments, the method and system of FIG. 1 is run over a network comprising one or more processors. In some embodiments, the method of FIG. 1 is computer-implemented.

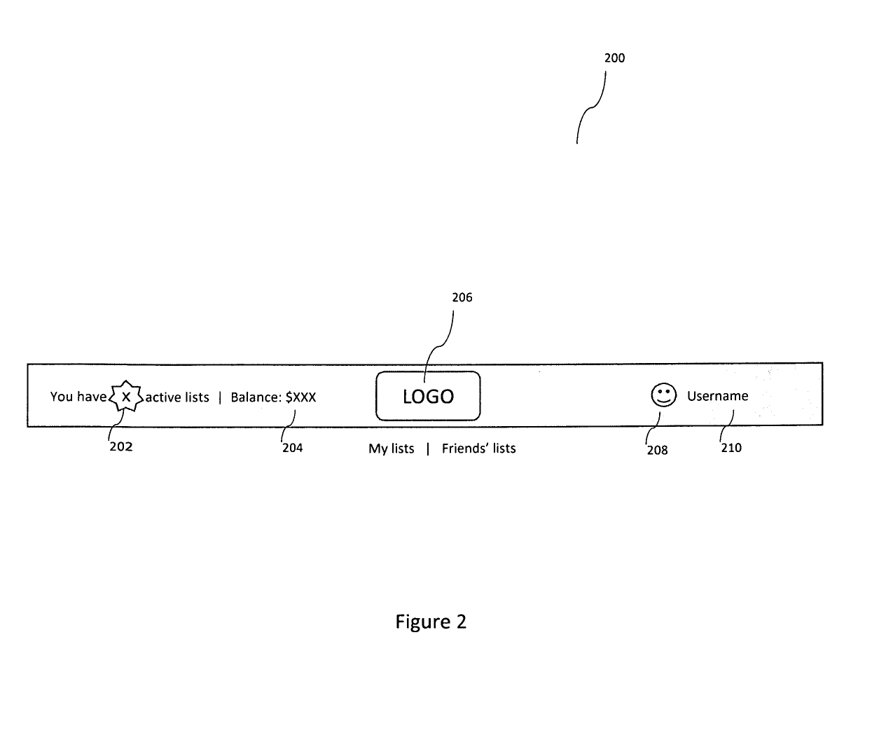

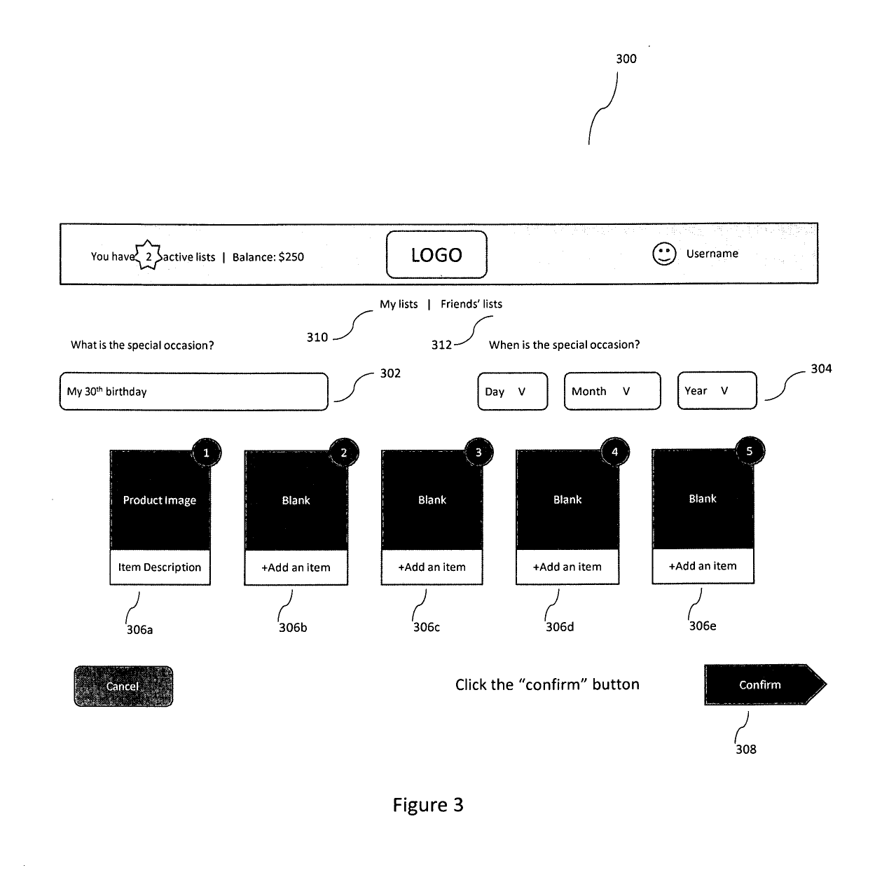

FIG. 2, in some embodiments, presents an example header bar 200 for the example user interfaces depicted in FIGS. 3-7. Turning to FIG. 2, a header bar 200 may include an active list indicator 202, an account balance indicator 204, a logo 206, a user profile picture 208, and user name 210. In some embodiments, the user “Jane Doe” may be an individual user, the head of a household or organization, or the agent of an organization. The user “Jane Doe” is interested in receiving gifts that she has selected herself, or has selected gifts for another person. The active list indicator 202 shows how many lists the user “Jane Doe” has active. In some embodiments, clicking on the indicator navigates to the user's active lists. The account balance indicator 204 shows the cash balance amount that the user “Jane Doe” may spend on her own gift list or that of another user.

Turning to FIG. 3, a screen shot 300 for an interface for creating a gift list, in some embodiments, may include a field 302 for naming a new list, pull down selectors 304 for specifying the end date (i.e., expiration or first time limit) for the gift list, gift choice icons 306a-e, confirmation button 308, a list selectors 310 and 312.

A user “Jane Doe” may enter the name of her gift list in field 302, possibly relating to a life event such as a birthday or graduation. The pull down selectors 304 are used to specify an ending date for the gift list. In some embodiments, the ending date sets the time and/or day upon which the first time limit expires as set forth in system 100. In some embodiments, upon selection of gift choice icons 306a-e, a user navigates to another interface for the selection of a gift item. In the depicted screen shot, icon 306a indicates that a laptop has been selected as gift choice number 1. If user “Jane Doe” wished to select a second item for her gift list, icon 306b could be selected, and so on. Once the desired number and identify of gift items is selected, user “Jane Doe” can select confirmation button 308. In some embodiments, confirmation button 308 navigates to additional confirmatory interfaces and/or publication of the gift list. In some embodiments, user “Jane Doe” may rank the gift items in order of preference. In some embodiments, the rank order is determined by the placement of gifts left to right in row fashion. In some embodiments, a user “Jane Doe” can change the ranking by dragging and dropping gift list icons 306a-e in the order desired from left to right. In some embodiments, list selector 310 navigates to user “Jane Doe's” active gift lists. In some embodiments, list selector 312 navigates to the gift lists of the friends of user “Jane Doe.”

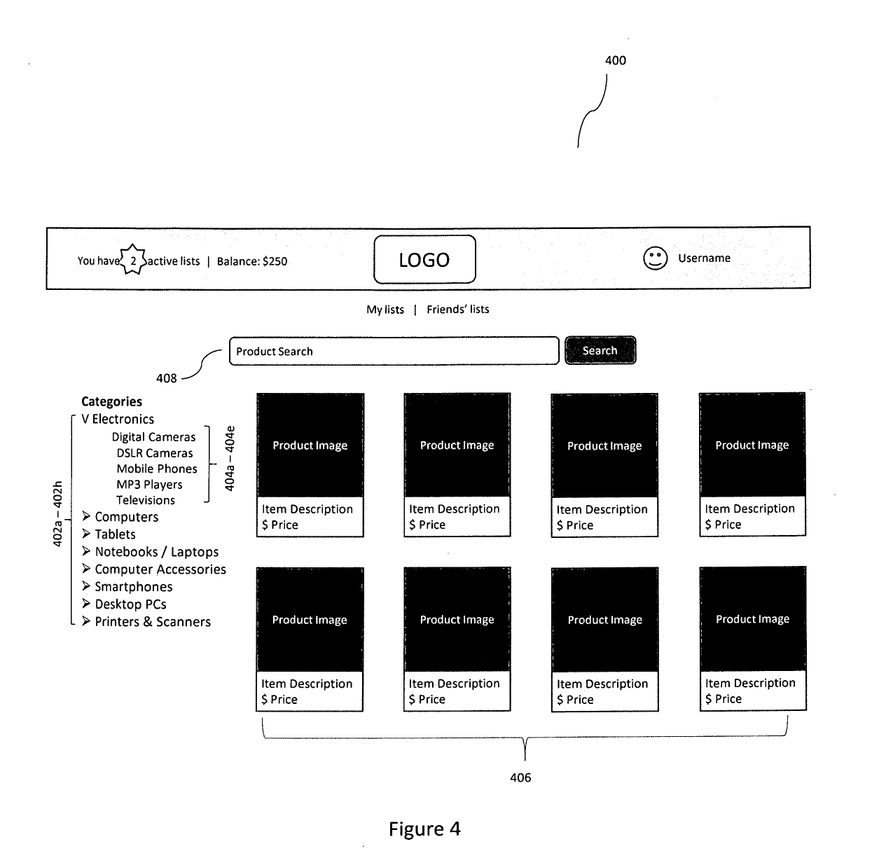

Turning to FIG. 4, a screen shot 400 for an interface for selecting gift choices to populate a gift list with one or more gift items, in some embodiments, may include categories 402a-h, subcategories 404a-e, gift choices 406, and search field 408. Selection of category 402a may result in the display of subcategories 404a-e. Selection of any category or subcategory displays a listing of gift choices 406, which when selected are added to the user's wish list. As an alternative method of locating gift choices, a user may utilize search field 408 to search for a specific product name or category.

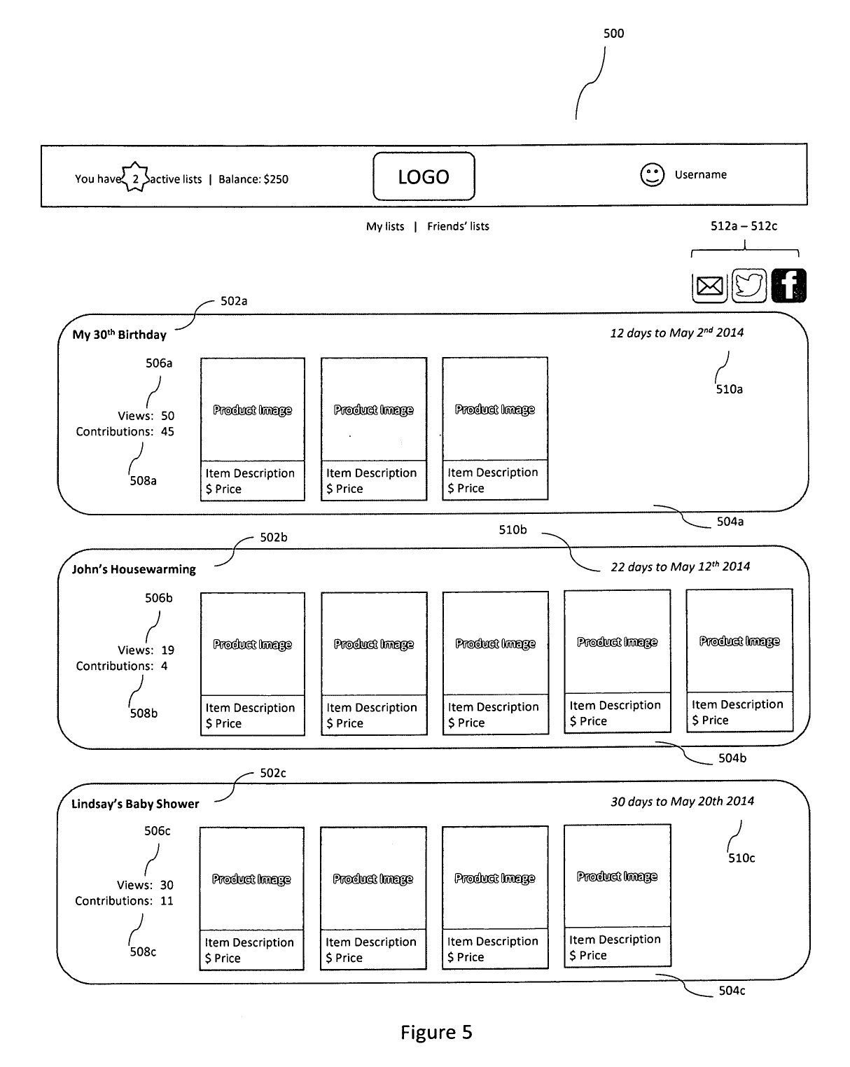

Turning to FIG. 5, a screen shot 500 for an interface for a user “Jane Doe” to view her published gift lists, in some embodiments, may include gift list names 502a-c, gift lists 504a-c, views indicators 506a-c, contributions indicator 508a-c, time remaining indicators 510a-c, and sharing icons 512a-c. In some embodiments, gift list names 502a-c and gift lists 504a-c correspond to those created as described above. In some embodiments, gift list items are displayed by icons as depicted in 504a-c. In some embodiments, the ranking of gifts is depicted by the left to right arrangement of such icons. If a list contains multiple rows of icons, the ranking continues from left to right in the second row, and so on. In some embodiments, view indicators 506a-c depict the number of other users who have viewed each gift list. In some embodiments, contributions indicators 508-c depict the number of individual contributions by gift givers (“at least two other parties” in FIG. 1) to a fund pool of each gift list. The number of individual contributions can be equal to, or if at least one gift giver contributes more than once more than, the number of gift givers who have contributed funding. In some embodiments, time remaining indicators 510a-c depict the remaining time before a gift list expires (i.e., the time remaining for gift givers to contribute funding to a fund pool). In some embodiments, sharing icons 512a-c navigate the user to interfaces for sharing the gift list via social media or email.

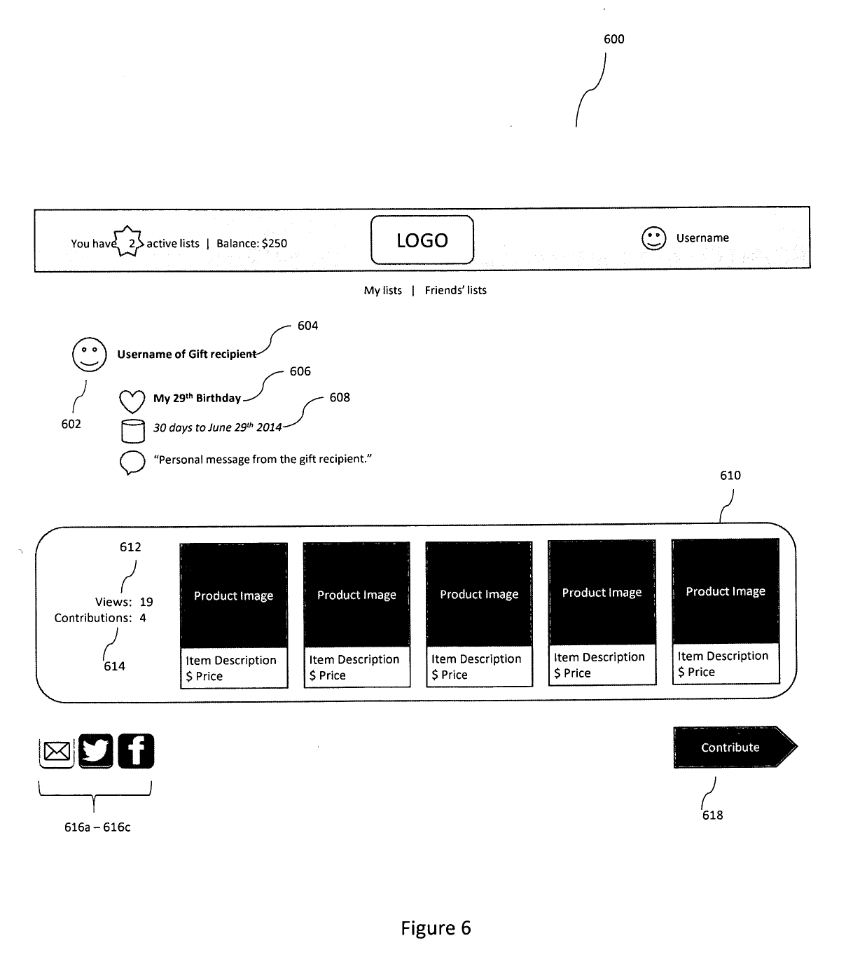

Turning to FIG. 6, a screen shot 600 for an interface for a gift giver to view a user's published gift list, in some embodiments, may include a user (“first party” in FIG. 1) profile picture 602, a user name 604, a gift list name 606, a time remaining indicator 608, a gift list 610, views indicator 612, contributions indicator 614, sharing icons 616a-c, and contribution button 618. Several of these features are self-explanatory or have been described above. In some embodiments, sharing icons 616a-c navigate a gift giver to interfaces for sharing the gift list via social media or email. In some embodiments, selecting the contribution button 618 navigates the gift giver to a contribution interface.

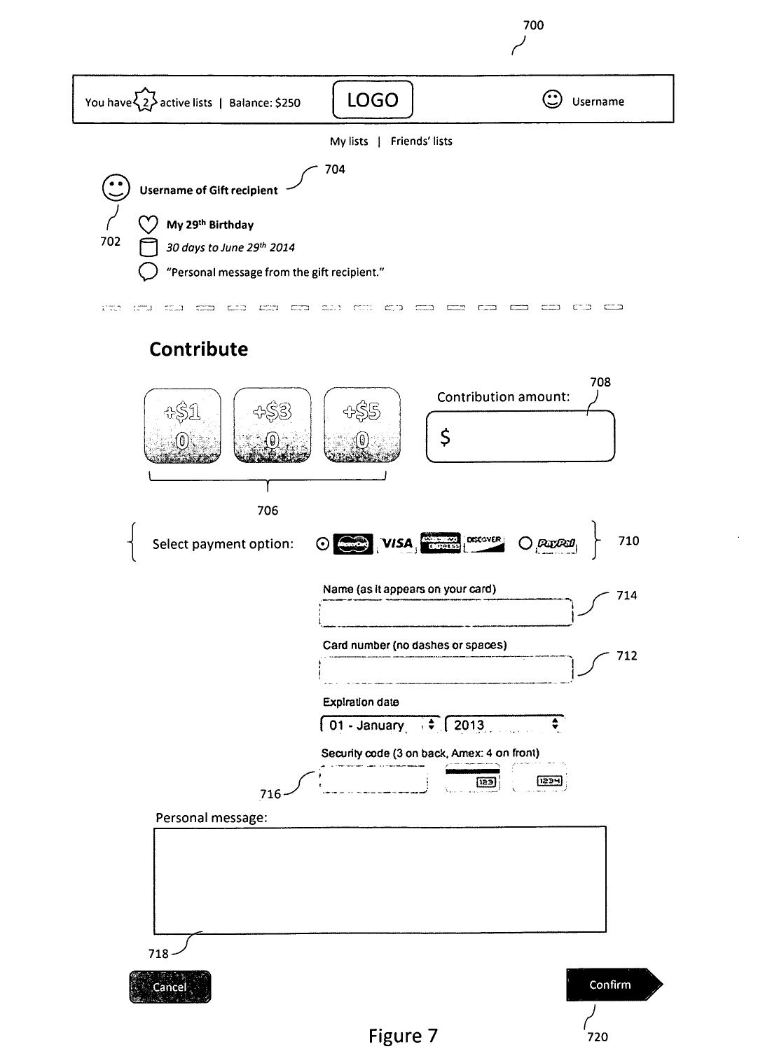

Turning to FIG. 7, a screen shot 700 for an interface for a gift giver to contribute to a user's gift list, in some embodiments, may include a user profile picture 702, a user name 704, contribution multiplier icons 706, balance total indicator 708, payment selector 710, card number field 712, payer name 714, card security code 716, message field 718, and confirmation button 720. Several of these features are self-explanatory or have been described above. In some embodiments, contribution multiplier icons 706 may be selected, optionally more than once, to generate a contribution amount populated in balance total indicator 708. For example, a gift giver may click on a $10 icon once and a $30 icon once to generate a balance of $40. Items 710, 712, 714, and 716 are standard payment options and details required for processing payments. In some embodiments, a gift giver may wish to include a message to the gift receiver, and can write such a message in message filed 718. In some embodiments, pressing confirmation button 720 navigates a gift giver to a payment confirmation and/or other interfaces.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for gift giving are provided. Having described certain implementations of methods and apparatus for gift giving, it will now become apparent to one of skill in the art that other implementations incorporating the concepts of the disclosure may be used. Therefore, the disclosure should not be limited to certain implementations, but rather should be limited only by the spirit and scope of the following claims.

1. A method comprising:
a. facilitating a first party in creating a gift list comprised of one or more gift items sold by one or more networked merchants;
b. providing for at least two other parties to view the gift list;
c. providing for the at least two other parties to fund the one or more gift items by contributing money to a fund pool; and
d. causing the purchase of at least one gift item from the networked merchant.

2. The method of claim 1, further comprising causing the closing of a sale of the gift item when the money in the fund pool equals or exceeds the price of the gift item.

3. The method claim 2, further comprising causing delivery of the gift item to the first party.

4. The method of claim 1, further comprising enabling the first party to view the fund pool value.

5. The method of claim 1, further comprising enabling the first party to contribute money to the fund pool.

6. The method of claim 1, wherein a first time limit is specified for the contribution of money to the fund pool by the at least two other parties.

7. The method of claim 1, wherein the first party ranks the gift items on the gift list in order of preference.

8. The method of claim 7, wherein the ranking order determines the priority by which money in the fund pool is applied to the purchase of gift items.

9. The method of claim 8, wherein the closing of a sale of the top-ranked gift item is triggered when the money in the fund pool equals or exceeds the price of the top-ranked gift item.

10. The method of claim 8, wherein the top-ranked gift item is not purchased if the fund pool does not equal or exceed the price of the top-ranked gift item before expiration of a time limit.

11. The method of claim 10, wherein upon expiration of the time limit, the closing of a sale of the next highest-ranked gift item is triggered if the money in the fund pool equals or exceeds the price of the next-ranked gift item.

12. The method of claim 1, wherein upon expiration of a time limit, the closing of a sale is triggered for the most highly-ranked gift item for which the money in the fund pool equals or exceeds the price of the gift item.

13. The method of claim 12, wherein more than one gift item sale is closed, in order of ranking and where the fund pool equals or exceeds the price of more than one gift item.

14. The method of claim 1, further comprising enabling the first party to contribute money to the fund pool after expiration of a first time limit.

15. The method of claim 14, wherein a second time limit is specified for the contribution of money by the first party.

16. The method of claim 1, further comprising enabling the one or more networked merchants to modify the listed price of a gift list item.

17. The method of claim 1, wherein the method is computer-implemented.

18. A system comprising:
a processor; and
a memory, the memory storing instructions that, when executed by the processor, cause the processor to:
receive, via a network, from a first party computing device, a selection of one or more gift items offered for sale by one or more networked merchants, wherein the selection comprises a gift list;
receive, via the network, from at least two other party computing devices, payments into a fund pool;
analyze, via the processor, whether the fund pool is of sufficient value to purchase one or more gift items on the gift list; and
cause, via the network, the purchase of at least one gift item from a networked merchant.

19. A non-transitory computer readable medium, where the computer readable medium stores instructions that, when executed by the processor, cause the processor to:
receive, via a network, from a first party computing device, a selection of one or more gift items offered for sale by one or more networked merchants, wherein the selection comprises a gift list;
receive from at least two other party computing devices, payments into a fund pool;
analyze whether the fund pool is of sufficient value to purchase one or more gift items on the gift list;
cause the purchase of at least one gift item from a networked merchant.
